(19) United States
(12) Patent Application Publication
(10) Pub. No.: US 2004/0243447 A1
(43) Pub. Date: Dec. 2, 2004

(54) Hospital risk management support system

(75) Inventors: Takuya Kamiyama, Tokyo (JP); Yoshitaka Bito, Tokorozawa (JP); Hideyuki Ban, Kodaira (JP); Hajime Sasaki, Kawasaki (JP); Yasushi Kanno, Osaka (JP)

Correspondence Address: Stanley P. Fisher, Reed Smith LLP, Suite 1400, 3110 Fairview Park Drive, Falls Church, VA, 22042-4503, US

(73) Assignee: Hitachi., Ltd.

(21) Appl. No.: 10/754,582

(22) Filed: Jan. 12, 2004

(30) Foreign Application Priority Data
May 28, 2003 (JP) 2003-150083

(51) Int. Cl. G06F 17/60

(52) U.S. Cl. 705/3

(57) ABSTRACT

The present invention can provide a hospital risk management support system which can enhance the objectivity of an incident report and improve the input efficiency. It has a related event extraction part extracting an event related to an incident from an operation history stored into an electronic medical records database, an incident report generation records part compounding the contents of an auto input having information on the chronological event extracted from the related event extraction part and the contents of a manual input in which the related event information is manually inputted in an incident input and output part so as to create an incident report and storing it in an incident database.

### BACKGROUND OF THE INVENTION

The present invention relates to an information system in the medical field. More specifically, the present invention relates to an information system creating and supporting an incident report based on information on an electronic medical records system.

In consideration of stable hospital management, it is important to prevent a medical accident to reduce a risk about a medical accident lawsuit to a minimum. To predict and prevent an accident, how an incident report (near-miss report) of a medical accident or an incident which cannot lead to an accident, but can be dangerous, is utilized is the key. To diagnose the cause of an incident, it is necessary to objectively and exactly describe the causal relationship between the acts of the concerned person and the related worker in a report chronologically. In a conventional report on paper, however, the contents of a report written and submitted by a person giving a report (medical worker such as a doctor or a nurse) includes many inadequate points and insufficient explanations. Accordingly, there is a technique which can quickly give an electronic incident report and can report it by simplified input and an exact structured text hard to be affected by differences among individuals by inputting an essential input item to a template in a fixed format. For example, see “Iryojohogaku”, Japan Journal of Medical Informatics, 21(1), p.77-82 (2001).

In the prior art, however, from the memory of the concerned person of an incident and the related worker, it is difficult to exactly describe the causal relationship chronologically. In addition, to enhance the exactness, tremendous work is required just to collect patchy information described in a medical record or an order slip.

### SUMMARY OF THE INVENTION

An object of the present invention is to provide a hospital risk management support system which can enhance the objectivity of an incident report and improve the input efficiency.

Accordingly, the present invention can realize a system supporting hospital risk management by extracting an event related to an incident from information on the instruction of a doctor and the implementation of a nurse stored in an electronic medical records database for utilization for an incident report and by recording the electronic incident report while ensuring the exactness. A hospital risk management support system of the present invention has a function of extracting an event related to an incident from an operation history of each electronic medical records client to input it to an incident report.

As shown in FIG. 1, a hospital risk management support system of the present invention has an incident control part 1, an incident input and output part 2, an electronic medical records database 3, and an incident database 4. The incident control part 1 has a related event extraction part 8 extracting an event related to an incident from an operation history stored in the electronic medical records database 3.

An incident report generation records part 9 compounds the contents of an auto input having information on the chronological event extracted by the related event extraction part 8 and the contents of a manual input in which related event information 6 is manually inputted in the incident input and output part 2 to create an incident report and stores it in the incident database 4. Further, a moving image and voice photographed by a video camera set in a sickroom or the like are recorded in engagement with an incident and the electronic incident report is recorded while ensuring the exactness, thereby realizing a system supporting hospital risk management.

To exactly identify time and the contents of an act in which an electronic medical record is operated and the states of time therebefore and thereafter, as shown in FIG. 12, a hospital risk management system of the present invention has an incident control part 1, an incident input and output part 2, and a monitoring image control part 32. The monitoring image control part 32 has a camera 31 installed in the position in which a monitoring object can be observed, a camera controller 34 controlling the camera, a monitoring image records part 35 recording monitoring images into a monitoring image database 33 in succession, and a monitoring image extraction part 36 extracting a monitoring image from desired extraction time and the camera.

The incident control part 1 has an operation history call part 7 calling from an electronic medical records database 3 an operation history of an electronic medical records client, and a related event extraction part 8 extracting from the operation history an event related to an incident based on occurrence time, concerned person's information, patient information and act information of occurrence information 5, which are inputted in the incident input and output part 2.

The related event extraction part 8 obtains the corresponding camera ID from an electronic medical records client which has recorded the extracted event, obtains a predetermined time interval which has predicted that the event is monitored in such a manner that it is started from the time information to be ended, transmits them to the monitoring image extraction part 36, and transmits a monitoring image extracted by the monitoring image extraction part 36 and the contents of the event as the contents of an auto input to an incident report generation records part 9. The incident report generation records part 9 compounds the contents of the auto input and the contents of a manual input manually inputted to related event information 6 of the incident input and output part 2 so as to create an incident report.

When information related to the privacy of a patient is included in a monitoring image, the monitoring image must be displayed with patient recognition. As shown in FIG. 20, an incident control part 1 has a patient privacy management part 45. The patient privacy management part displays patient recognition 47 on an incident report display screen 46, as shown in FIG. 21, for a monitoring image in which a patient with a bed in a sickroom where the privacy of the patient should be respected may be photographed, inputs information which can specify an individual, such as a password registered by each patient, and prevents the monitoring image from being displayed when not depressing a recognize button 48. For a place where the privacy of the patient is respected, a patient entry managed table 51 as shown in FIG. 24 may be used to show a room with entry restrictions of patients and to obtain patient recognition for a room without entry restrictions.

### BRIEF DESCRIPTION OF THE DRAWINGS

FIG. 1 is a diagram showing the schematic configuration of a function block and a data flow of a hospital risk management support system according to a first embodiment of the present invention;

FIG. 2 is a diagram showing an example of an operation history recorded into an electronic medical records database according to the first embodiment of the present invention;

FIG. 3 is a diagram showing an example of an operation attribute table showing correspondence of operation names with acts and the like corresponding to the operations of an electronic medical record according to the first embodiment of the present invention;

FIG. 4 is a diagram showing an example of an incident report input/reference screen according to the first embodiment of the present invention;

FIG. 5 is a diagram showing an example of an incident report display screen according to the first embodiment of the present invention;

FIG. 6 is a flowchart showing a typical operation of a first hospital risk management support system of the present invention;

FIG. 7 is a flowchart showing an example of the processing of extracting related events shown in FIG. 6;

FIG. 8 is a diagram showing an operation history used in another example according to the first embodiment of the present invention;

FIG. 9 is a diagram showing an example of an incident report display screen according to the first embodiment of the present invention;

FIG. 10 is a diagram showing an example of the state of notifying an event at the occurrence of an incident according to the first embodiment of the present invention;

FIG. 11 is a diagram showing an example of the configuration of a system notifying an event of FIG. 10;

FIG. 12 is a diagram showing the schematic configuration of a function block and a data flow of a hospital risk management support system according to a second embodiment of the present invention;

FIG. 13 is a diagram showing an example of the position relation between camera arrangement and patients in a sickroom according to the second embodiment of the present invention;

FIG. 14 is a diagram showing an example of a camera managed table managing the installation places of cameras according to the second embodiment of the present invention;

FIG. 15 is a diagram showing an example of an electronic medical records client managed table managing the installation places of electronic medical records clients according to the second embodiment of the present invention;

FIG. 16 is a diagram showing an example of an operation attribute table managing operation attributes and image extraction conditions of an electronic medical records client according to the second embodiment of the present invention;

FIG. 17 is a diagram showing an example of an incident report display screen capable of displaying a monitoring image according to the second embodiment of the present invention;

FIG. 18 is a flowchart showing a typical operation of a hospital risk management support system capable of inputting a monitoring image to an incident report according to the second embodiment of the present invention;

FIG. 19 is a flowchart showing an operation extracting related events shown in FIG. 18;

FIG. 20 is a diagram showing the schematic configuration of a function block and a data flow of a hospital risk management support system capable of inputting a monitoring image to an incident report in consideration of the privacy of a patient according to a third embodiment of the present invention;

FIG. 21 is a diagram showing an example of an incident report display screen capable of displaying a monitoring image in consideration of the privacy of a patient according to the third embodiment of the present invention;

FIG. 22 is a diagram showing an example of a related event table managing related patient recognition for each related event according to the third embodiment of the present invention;

FIG. 23 is a diagram showing an example of a patient recognition check table deciding “related patient recognition” of the related event table of FIG. 22;

FIG. 24 is a diagram showing an example of a patient entry managed table showing whether the installation places of electronic medical records clients and cameras restrict patient entry according to the third embodiment; and

FIG. 25 is a flowchart showing a typical recognition operation of a hospital risk management support system capable of controlling the privacy of a patient to a monitoring image according to the third embodiment of the present invention.

### DETAILED DESCRIPTION OF THE PREFERRED EMBODIMENTS

A hospital risk management support system of the present invention having an incident input and output part inputting occurrence time, concerned person's information, patient information and act information related to an incident, and an incident control part controlling information on an incident, the incident control part having an operation history call part calling from an electronic medical records database an operation history which has recorded the history of operation of at least one electronic medical records client, a related event extraction part extracting from the operation history an event related to an incident having at least occurrence time and the contents of an act related operation based on all or part of the occurrence time, the concerned person's information, the patient information and the act information, which are inputted in the incident input and output part, and an incident report generation records part compounding the contents of an auto input having information on the chronological event extracted by the related event extraction part and the contents of a manual input in which information on the event is manually inputted in the incident input and output part so as to create an incident report.

A hospital risk management support system of the present invention having (a) an incident input and output part inputting occurrence time, concerned person's information, patient information and act information related to an incident, (b) an incident control part controlling information on an incident, and (c) a monitoring image control part having a camera installed in the position in which a monitoring object can be observed, a camera controller controlling the camera, a monitoring image records part recording monitoring images photographed by at least one camera into a monitoring image database in succession, and a monitoring image extraction part extracting a monitoring image of desired extraction time and at least one camera, the incident control part having an operation history call part calling from an electronic medical records database an operation history which has recorded the history of operation of an electronic medical records client, a related event extraction part extracting from the operation history an event related to an incident having at least occurrence time and the contents of an act related operation based on all or part of the occurrence time, the concerned person's information, the patient information and the act information, which are inputted in the incident input and output part, the related event extraction part transmitting to the monitoring image extraction part the corresponding camera in the installation place of an electronic medical records client which has recorded the extracted event and predetermined extraction time which has predicted that the event is monitored in such a manner that the event is started from the occurrence time of the event to be ended, and an incident report generation records part inputting as the contents of an auto input a monitoring image related to the event extracted from the monitoring image extraction part and the contents of the event for compounding the contents of the event and the contents of a manual input manually inputted in the incident input and output part so as to create an incident report.

A hospital risk management support system of the present invention having (a) an incident input and output part inputting occurrence time, concerned person's information, patient information and act information related to an incident, (b) an incident control part controlling information on an incident, and (c) a monitoring image control part having a camera installed in the position in which a monitoring object can be observed, a camera controller controlling the camera, a monitoring image records part recording monitoring images photographed by at least one camera into a monitoring image database in succession, and a monitoring image extraction part extracting a monitoring image of desired extraction time and at least one camera, the incident control part having an operation history call part calling from an electronic medical records database an operation history which has recorded the history of operation of an electronic medical records client, a related event extraction part extracting from the operation history an event related to an incident having at least occurrence time and the contents of an act related operation based on all or part of the occurrence time, the concerned person's information, the patient information and the act information, which are inputted in said incident input and output part, the related event extraction part transmitting to the monitoring image extraction part the corresponding camera in the installation place of an electronic medical records client which has recorded the extracted event and predetermined extraction time which has predicted that the event is monitored in such a manner that the event is started from the occurrence time of the event to be ended, an incident report generation records part inputting as the contents of an auto input a monitoring image related to the event extracted from the monitoring image extraction part and the contents of the event for compounding the contents of the event and the contents of a manual input manually inputted in the incident input and output part so as to create an incident report, and a patient privacy management part which can display a monitoring image only when the monitoring image related to the privacy of a patient of the incident report is recognized by the input of information specifying an individual set by the patient.

The present invention provides a hospital risk management support system capable of creating an electronic incident report while ensuring the exactness in conjunction with an electronic medical record.

Embodiments of the present invention will be described below in detail using the drawings.

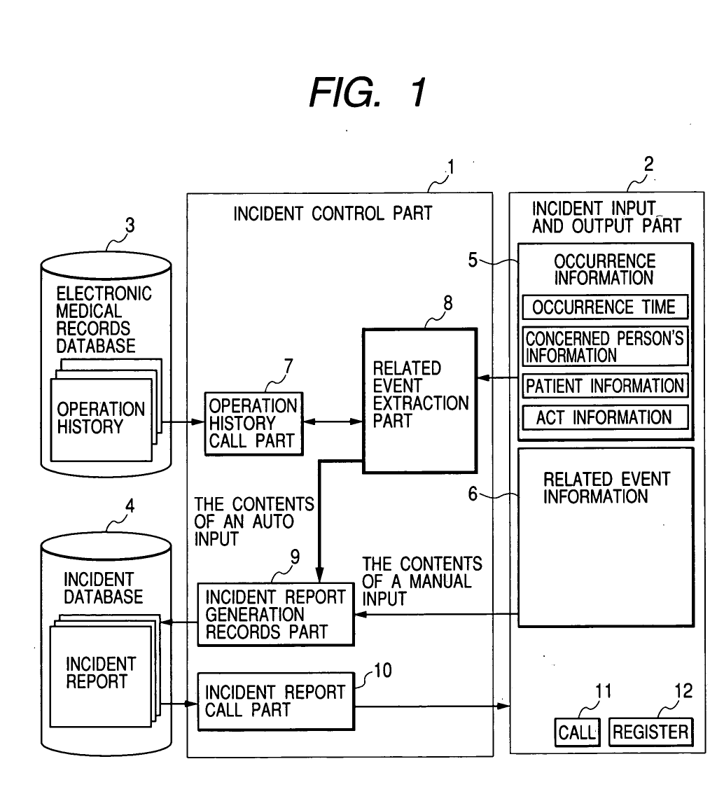

Using FIGS. 1 to 7, a first embodiment of a hospital risk management support system of the present invention will be described.

FIG. 1 is a diagram showing the schematic configuration of a function block and a data flow of a hospital risk management support system.

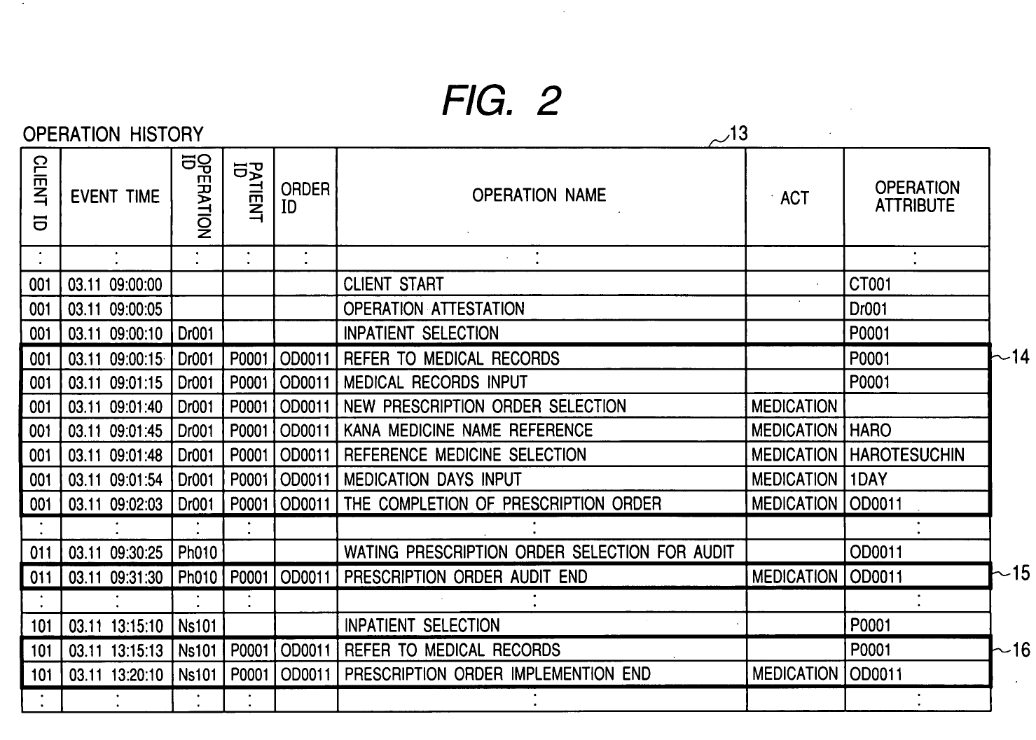

FIG. 2 is a diagram showing an example of an operation history 13 recorded into an electronic medical records database 3.

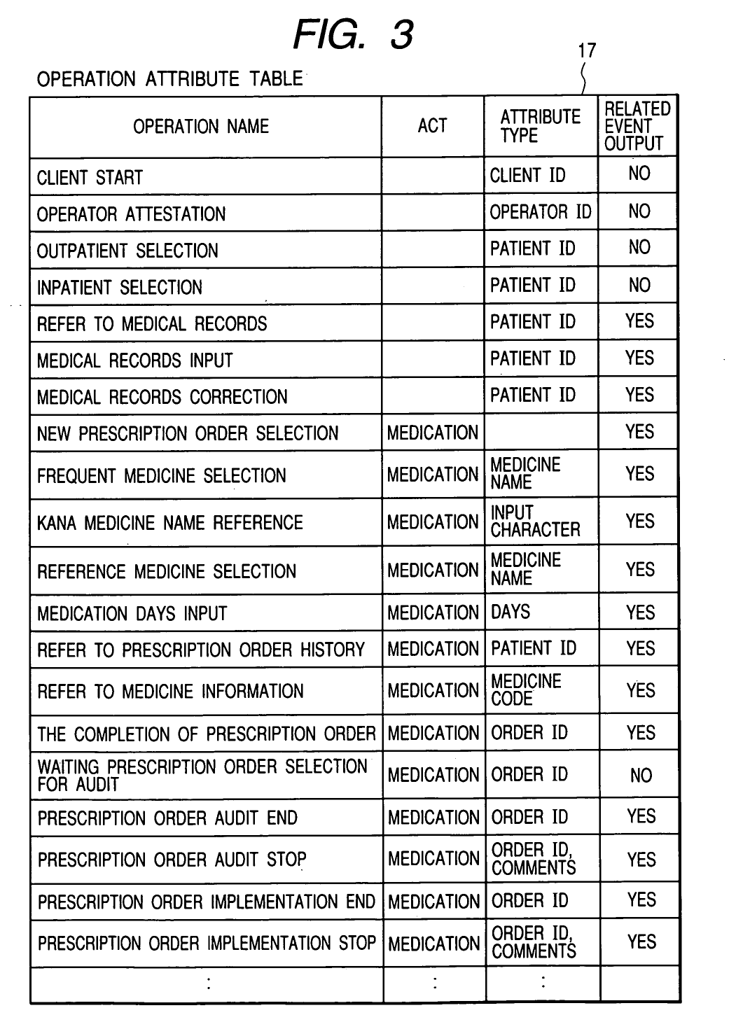

FIG. 3 is a diagram showing an example of an operation attribute table 17 showing correspondence of operation names with acts and the like corresponding to the operations of an electronic medical record.

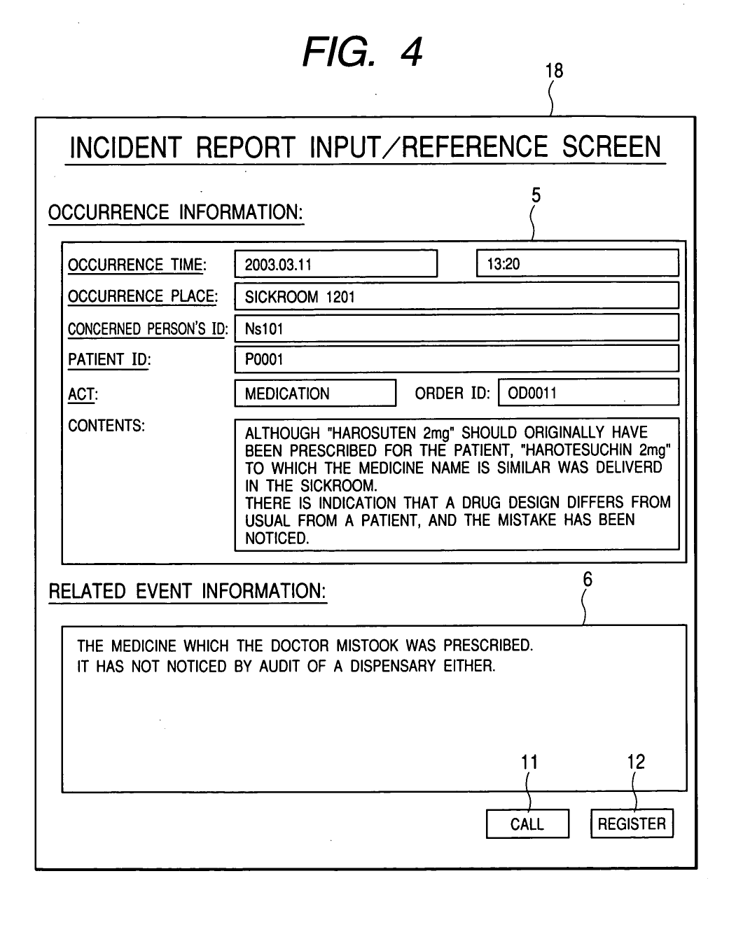

FIG. 4 is a diagram showing an example of an incident report input/reference screen 18.

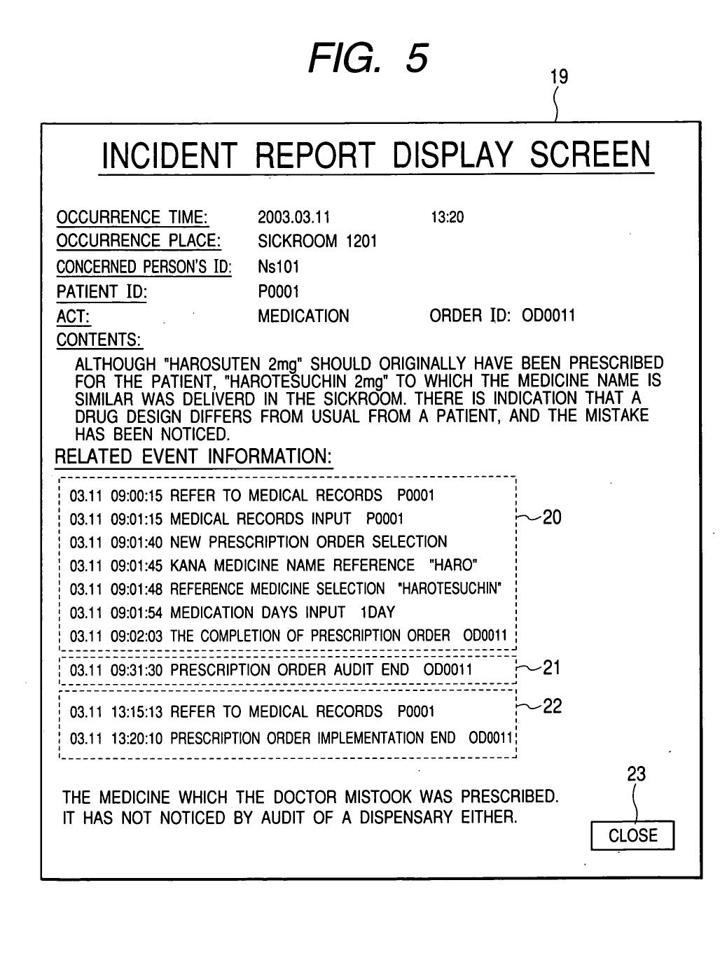

FIG. 5 is a diagram showing an example of an incident report display screen 19.

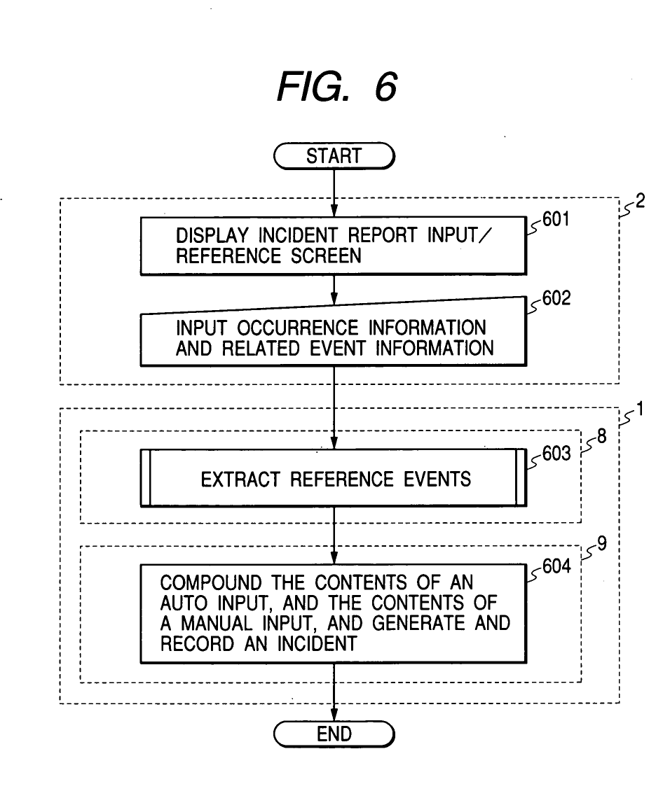

FIG. 6 is a flowchart showing a typical operation of a first hospital risk management support system of the present invention. The boxes of FIG. 6 indicated by the dotted lines correspond to the function block shown in FIG. 1.

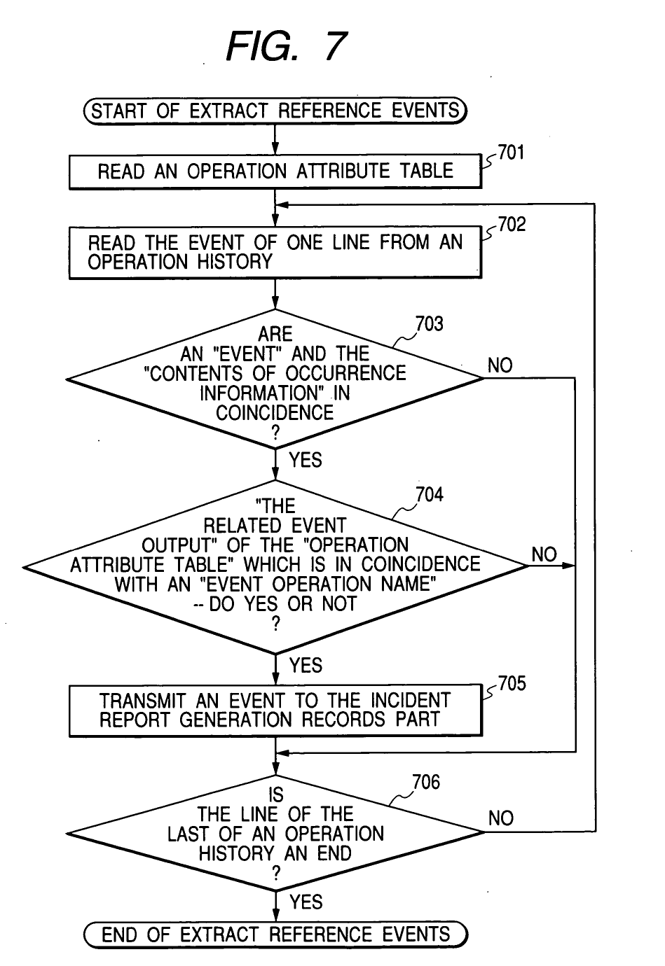

FIG. 7 is a flowchart showing an example of the processing of extracting related events shown in FIG. 6.

As shown in FIG. 1, a hospital risk management support system has an incident control part 1 and an incident input and output part 2. The incident control part 1 has an operation history call part 7 calling from an electronic medical records database 3 an operation history which has recorded the history of operation in each electronic medical records client, and a related event extraction part 8 extracting from the operation history an event of operation related to an incident based on occurrence information 5 (occurrence time, concerned person's information, patient information and act information), which is inputted in the incident input and output part 2.

Using FIGS. 1 to 5, registration of an incident will be described here with the flowcharts of FIGS. 6 and 7.

In step 601, an incident report input/reference screen 18 shown in FIG. 4 displayed on an incident input and output part 2 is displayed. In step 602, the contents of a manual input of occurrence information 5 and related event information 6 are inputted by a keyboard. When a register button 12 is pressed, the occurrence information 5 and the related event information 6 are transmitted as the contents of a manual input to an incident report generation records part 9. At the same time, the routine is moved from step 602 to step 603 so that the control is moved to an incident control part 1. The related event extraction of step 603 as the processing of a related event extraction part 8 will be described here using FIG. 7.

In step 701, an operation attribute table 17 of FIG. 3 is read. In step 702, the event of one line is read from an operation history 13 shown in FIG. 2 of each electronic medical records client recorded into an electronic medical records database 3. In step 703, whether the read event and the contents of the predetermined item among the items inputted to the occurrence information 5 are in coincidence is checked.

One or a combination of two or more items checked may be used. By way of example, whether an order ID and “OD0011” are in coincidence is checked. When they are not in coincidence, the routine is advanced to step 706. When they are in coincidence, the routine is advanced to step 704 and whether the related event output of the line of the operation attribute table 17 corresponding to an operation name of the read event is set to Yes or No is checked. When it is set to No, the routine is advanced to step 706. When it is set to Yes, the routine is advanced to step 705 to transmit information on a predetermined necessary item of one line from the contents of the read event to the incident report generation records part 9.

In this example, event time, an operation name and an operation attribute of one line are transmitted to the incident report generation records part 9 and the routine is advanced to step 706. In step 706, whether reading of the line of the last of the operation history 13 is completed is checked. When there are any remaining lines, the above processing is repeated from step 702. When there are no remaining lines, the processing of related event extraction of step 603 is ended. The processing of the related event extraction part 8 is ended by the above processing. The contents of an auto input are transmitted to the incident report generation records part 9. The processing is moved to the incident report generation records part 9.

In step 604, the contents of an auto input and the related event information 6 inputted in step 602 are compounded to record an incident report having the occurrence information 5 and the related event information 6 into an incident database 4. As the compounding method, for example, texts may be simply compounded in order of the contents of an auto input and the contents of a manual input. To clearly show the difference between the contents of an auto input and the contents of a manual input, the background color may be changed or a tag may be given.

The incident report recorded into the incident database 4 can be referred by inputting a reference condition into each item of the occurrence information 5 of the incident input/reference screen 18 to depress a call button 11 by a screen operation device such as a mouse. For example, patient ID “P0001” is inputted, a desired incident report is referred by an incident report call part 10, and the results can be displayed on an incident report display screen 19, as shown in FIG. 5.

For the related event information, a doctor's related event 20, a pharmacist's related event 21, a nurse's related event 22, as the contents of an auto input extracted from the operation history 13, and the contents of a manual input thereunder are displayed. When viewing the related event information, the doctor gave a description into an electronic medical record with reference to at least the medical record of the patient reported by the concerned person to implement a new prescription order. At this time, as the medicine selection method, “HARO” was inputted in the kana medicine name reference to implement reference. Although “HAROSUTEN” should originally have been selected from the list of reference results, “HAROTESUCHIN” to which the name is similar is found to have been selected by mistake.

The later audit of a dispensary was completed without noticing the mistake. It is found that the nurse, the last implementing person, referred to and checked the medical record, and implemented medication to the patient without noticing that HAROTESUCHIN was prescribed by mistake. The displayed screen is ended by depressing a close button 23 to return to the incident report input/reference screen 18 of FIG. 4.

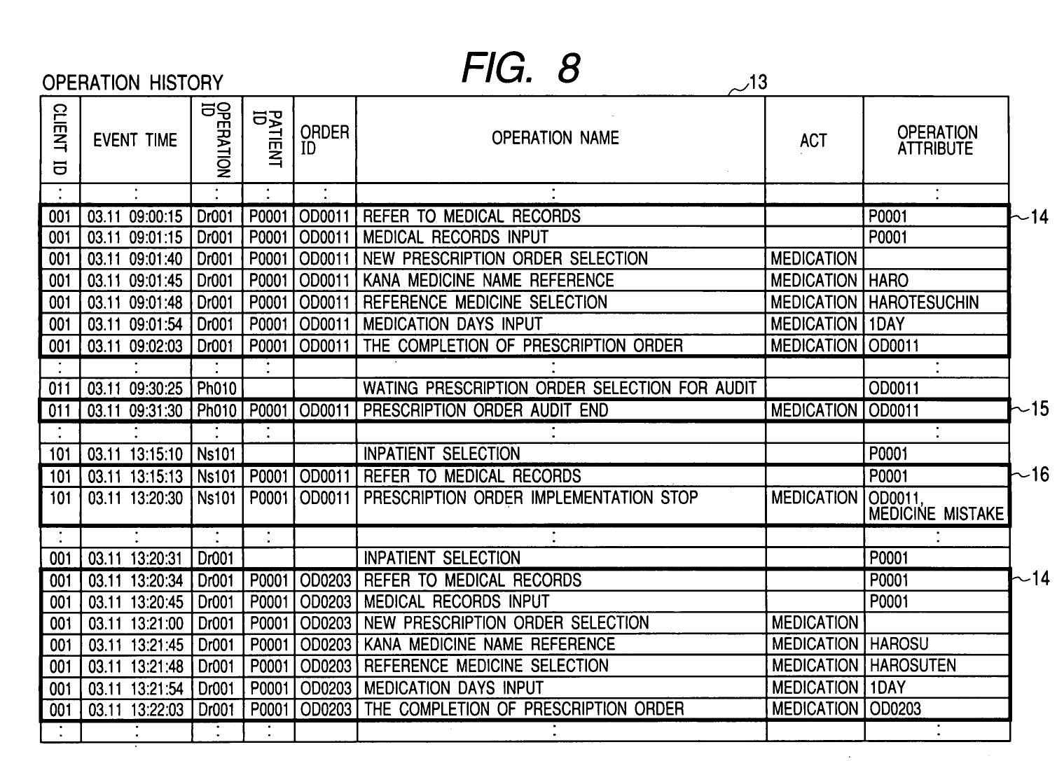

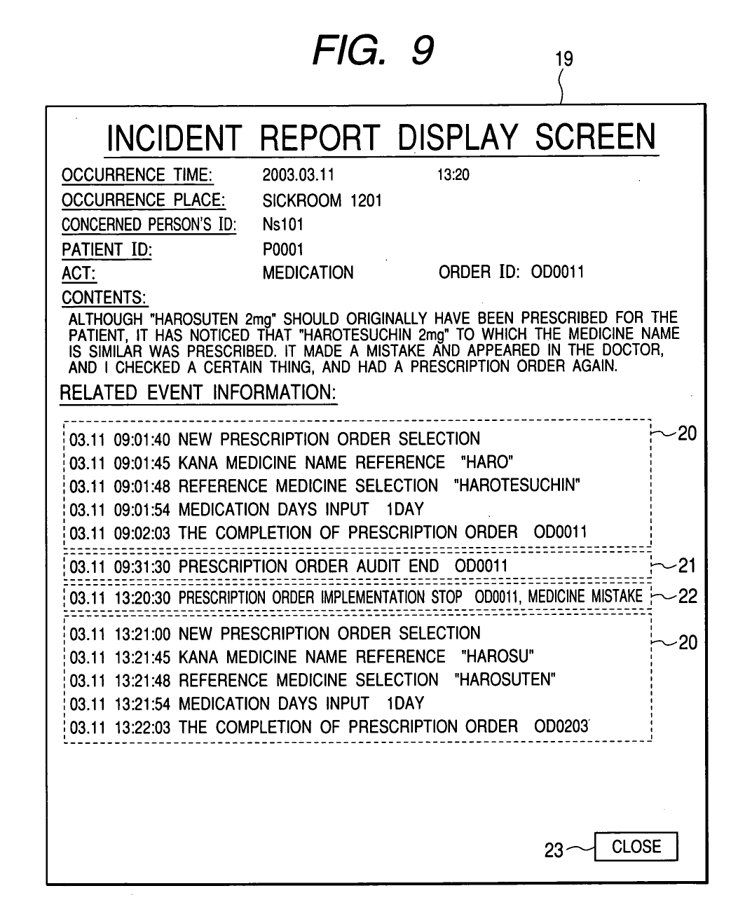

Another example using another operation history data for the contents of an auto input of related events will be described here using FIGS. 8 and 9.

FIG. 8 is a diagram showing an operation history 13 used in another example according to the first embodiment of the present invention.

FIG. 9 shows the results obtained by extracting related events by setting “medication” as an act of occurrence information 5 for the condition of step 703 of the flowchart of FIG. 7 showing the operation of the “related event extraction” of FIG. 6.

In the previous example, the patient noticed the mistake, which did not lead to an accident. In this example, there will be described the case that the nurse noticed the mistake to suitably check a certain thing with the doctor and the doctor implemented prescription again. When viewing the related event information of FIG. 9, the prescription audit of a doctor's related event 20 and a pharmacist's related event 21 is the same as the previous example. When viewing a nurse's related event 22, the nurse noticed that the medicine name was wrong before implementing medication to the patient to stop the prescription order implementation due to the medicine mistake. Thereafter, the doctor implemented a new prescription order. This time, it is found that “HAROSU” was inputted for the kana medicine name reference for reference to narrow the reference results and the original “HAROSUTEN” was selected from the list of the reference results.

The related events can be extracted by setting “medication” as an act of occurrence information 5 as the condition of step 703. The contents of an auto input extracted by a related event extraction part 8 may be outputted to a related event information 6 of an incident report input/reference screen 18 so as to be edited by a keyboard and be then transmitted to an incident report generation records part 9, whereby an incident report may be stored in an incident database 4.

In this case, for example, when the occurrence information 5 is inputted to depress a register button 12, the contents of an auto input are outputted to the related event information 6. After editing the outputted contents of the auto input, the register button 12 may be depressed again to store the same in the incident database 4. With an event outputted to the contents of an auto input as a reference key, a related event may be extracted again by the related event extraction part 8.

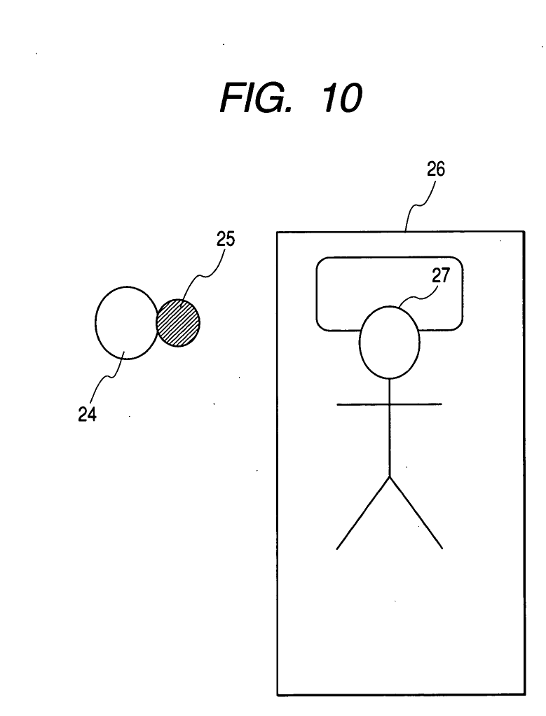

FIG. 10 is a diagram showing an example of the state of notifying an event at the occurrence of an incident according to the first embodiment of the present invention.

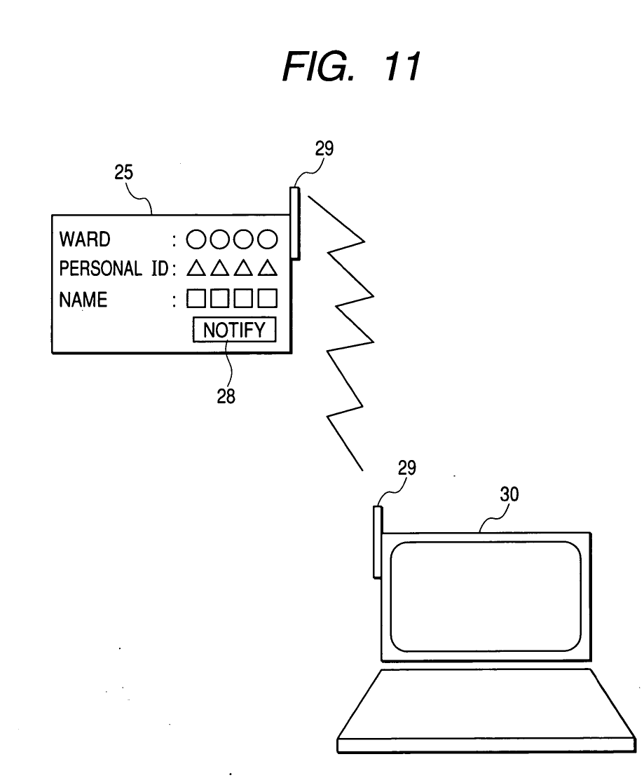

FIG. 11 is a diagram showing an example of the configuration of a system notifying an event of FIG. 10.

In the input to an incident report input/reference screen 18, as illustrated in FIG. 10, for example, when an incident occurs to a patient 27 lying in a bed 26, a concerned person 24 such as a nurse may use an incident event notice machine 25 to notify the incident to the hospital risk management support system and input occurrence information. As the incident event notice machine 25, a configuration using a name plate type as shown in FIG. 11 can be considered.

The concerned person 24 transmits the occurrence information via a radio antenna 29 to a hospital risk management system client 30 by depressing a notify button 28. Specifically, for example, occurrence time of occurrence information 5 is inputted based on time at which the notification of an incident event is received by an internal clock of the hospital risk management support system client 30 to permit input to a concerned person ID of the occurrence information 5 based on a personal ID registered into the incident event notice machine 25.

According to the first embodiment, a related event related to an incident is extracted from an operation history stored into an electronic medical records database to utilize time and the contents of an act in which an electronic medical record is operated. Simplified incident report creation can be done while maintaining the exactness.

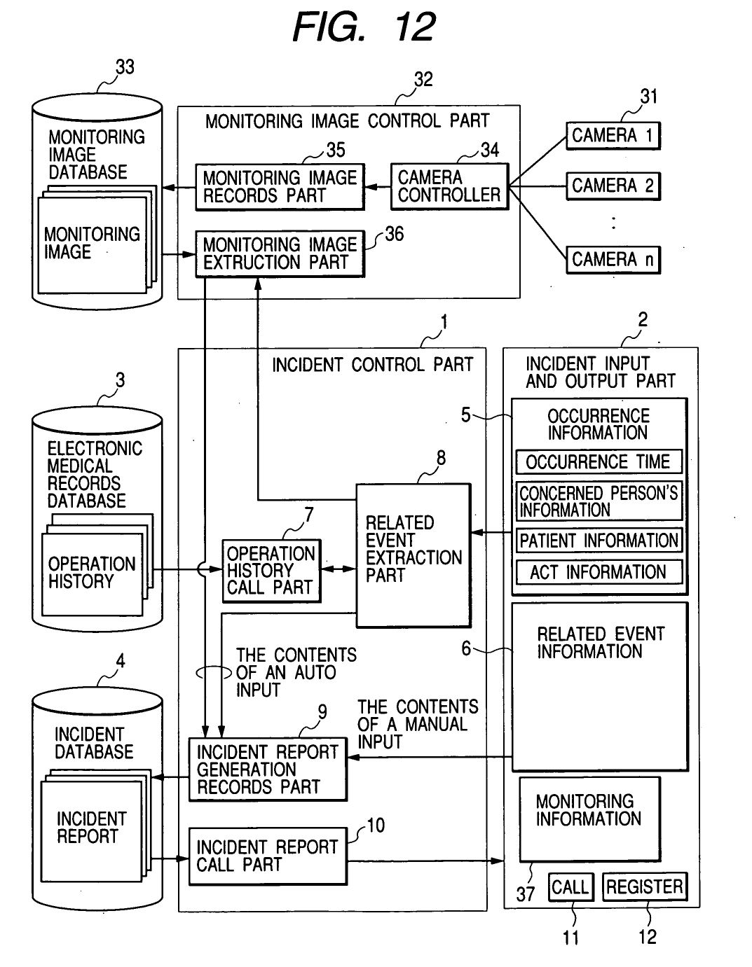

A hospital risk management support system of a second embodiment of the present invention will be described in detail using FIGS. 12 to 19. The second embodiment extends the first embodiment and controls an image of a camera installed in a sickroom in engagement with a related event of an incident for making possible recording and playing. That is, there is provided a risk management support system uniting a monitoring image and an incident report.

FIG. 12 is a diagram showing the schematic configuration of a function block and a data flow of a hospital risk management support system according to the second embodiment.

The configuration of FIG. 12 is different from that of FIG. 1 in that a camera ID and a function of computing image extraction time are added to a related event extraction part 8, and a camera 31 monitoring a sickroom and the like, a monitoring image control part 32, and a monitoring image database 33 are added. An incident input and output part 2 can display a monitoring image in monitoring information 37.

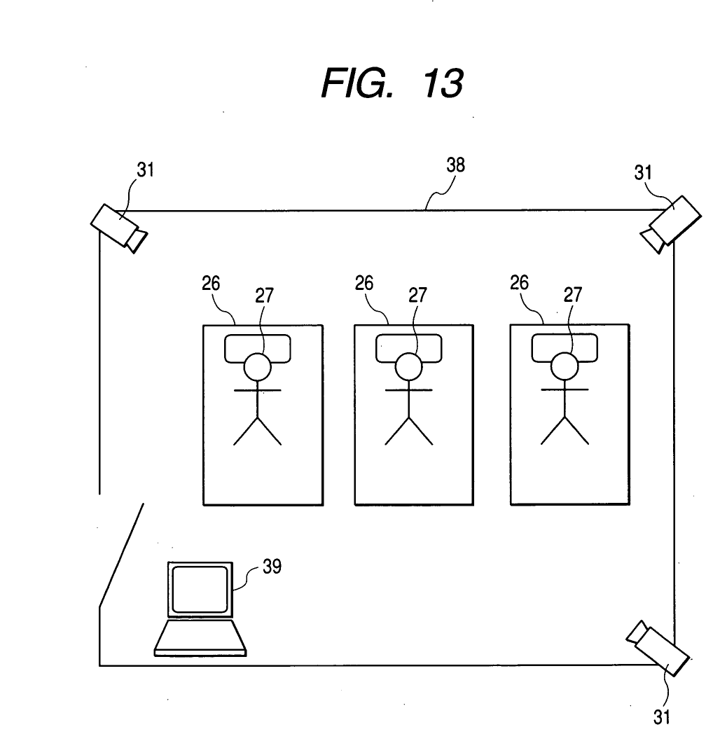

FIG. 13 is a diagram showing an example of the position relation between camera arrangement and patients in a sickroom according to the second embodiment and shows an example of arrangement of patients 27, an electronic medical records client 39 and installed cameras 31 in a sickroom 38.

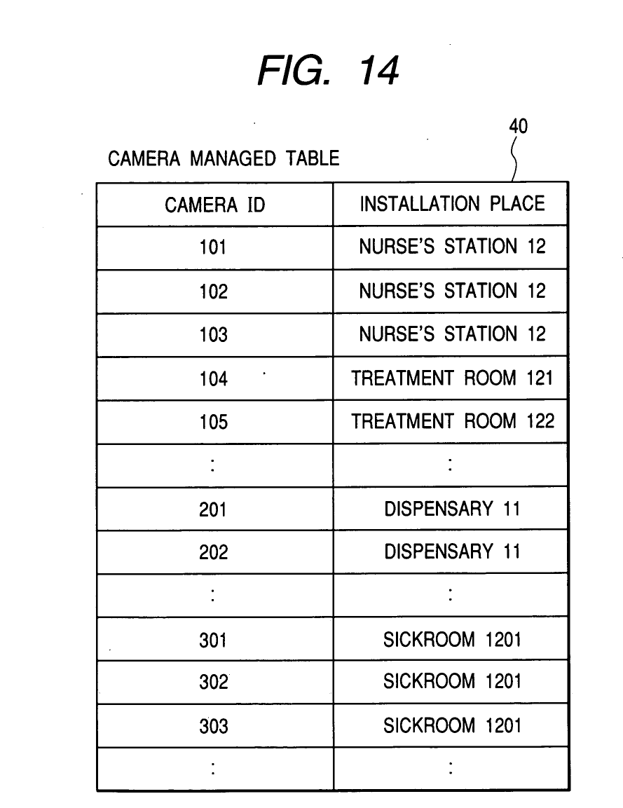

FIG. 14 is a diagram showing an example of a camera managed table managing the installation places of cameras according to the second embodiment and is a diagram showing an example of a camera managed table 40 managing the installation places of cameras installed in a room such as the sickroom 38 shown in FIG. 13.

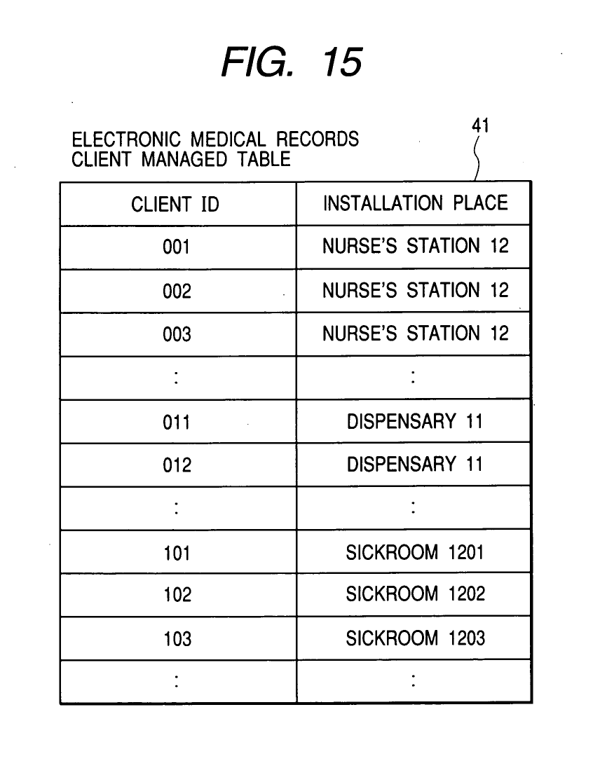

FIG. 15 is a diagram showing an example of an electronic medical records client managed table 41 managing the installation places of electronic medical records clients according to the second embodiment.

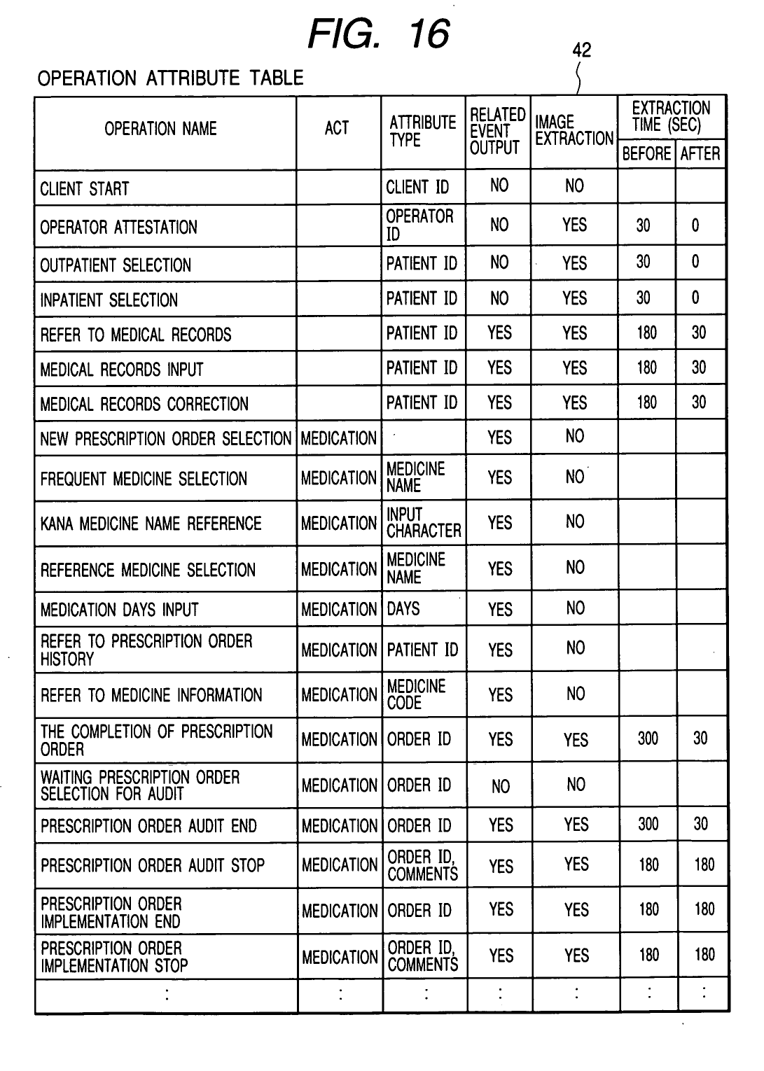

FIG. 16 is a diagram showing an example of an operation attribute table managing operation attributes and image extraction conditions of an electronic medical records client according to the second embodiment and is a diagram showing an example of an operation attribute table 42 managing an act for each operation corresponding to the operations of an operation history 13.

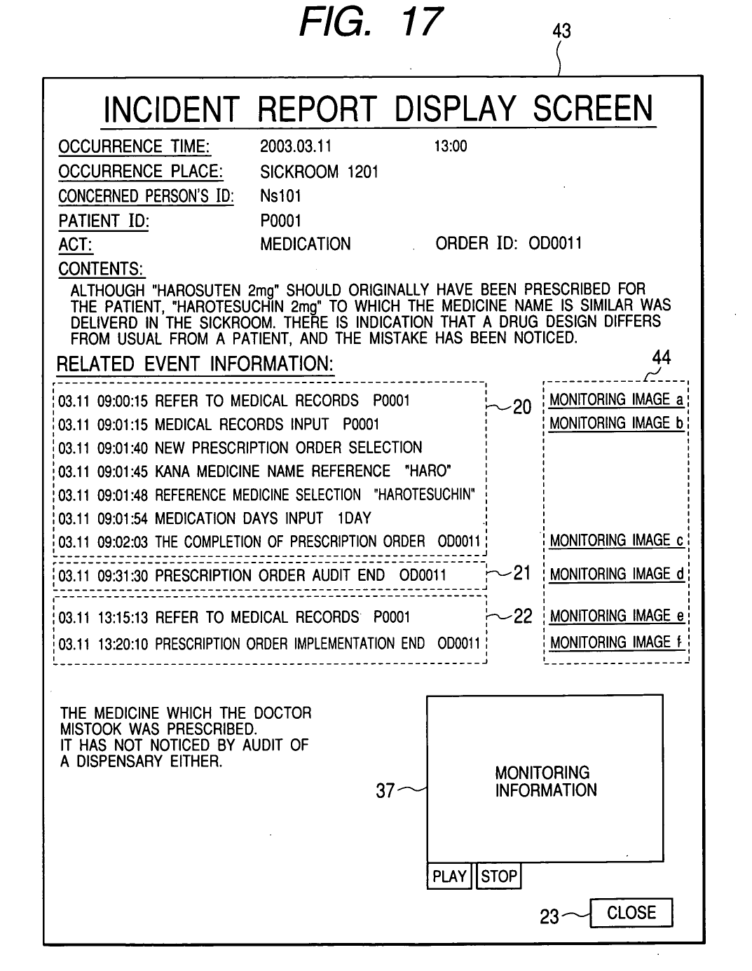

FIG. 17 is a diagram showing an example of an incident report display screen capable of displaying a monitoring image according to the second embodiment.

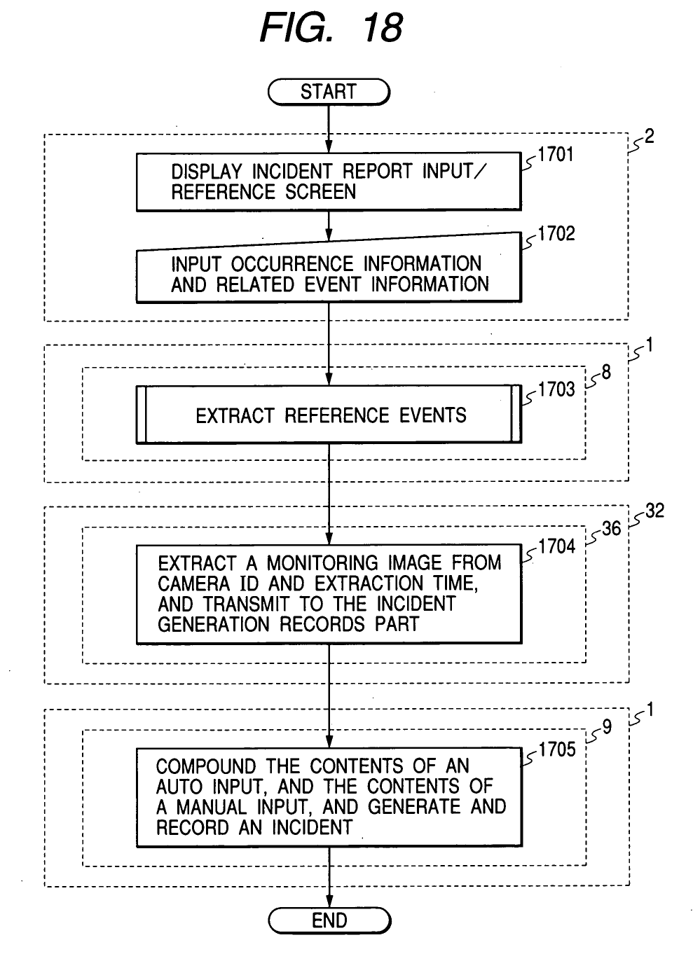

FIG. 18 is a flowchart showing a typical operation of a hospital risk management support system capable of inputting a monitoring image to an incident report according to the second embodiment. The boxes of FIG. 18 indicated by the dotted lines show processing corresponding to the function block shown in FIG. 12.

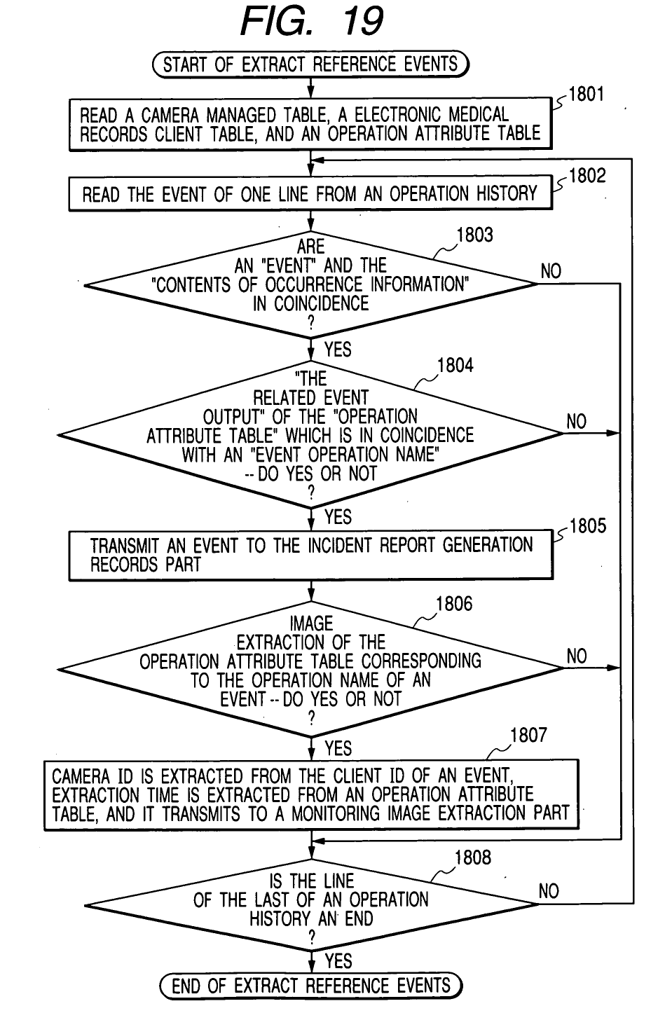

FIG. 19 is a flowchart showing an operation of “related event extraction” of FIG. 18 and is a flowchart showing an example of the processing of extracting related events.

As shown in FIG. 12, the hospital risk management support system has an incident control part 1, an incident input and output part 2, and a monitoring image control part 32. The monitoring image control part 32 has a camera controller 34 controlling a camera 31 installed in a sickroom 38 of FIG. 13, and a monitoring image records part 35 recording monitoring images into a monitoring image database 33.

The incident control part 1 has an operation history call part 7 calling from an electronic medical records database 3 an operation history 13 which has recorded the history of operation in each electronic medical records client, and a related event extraction part 8 extracting from the operation history an event of operation related to an incident based on occurrence information 5 (occurrence time, concerned person's information, patient information and act information), which is inputted in the incident input and output part 2, identifying a camera ID of a camera installed in a sickroom from the installation place of the electronic medical records client, like an electronic medical records client 39 installed in the sickroom 38 of FIG. 13, and computing image extraction time.

The monitoring image control part 32 has a monitoring image extraction part 36 extracting a monitoring image from the monitoring image database 33 based on the camera ID identified by the related event extraction part 8 and the extraction time.

Using FIGS. 12 to 17, registration of an incident will be described here with the flowcharts of FIGS. 18 and 19.

Steps 1701 to 1702 are the same as steps 601 to 602 explained in FIG. 6. An incident report input/reference screen 18 shown in FIG. 4 displayed on an incident input and output part 2 is displayed. In step 1702, occurrence information 5 and related event information 6 (the contents of a manual input) are inputted by a keyboard. When pressing a register button 12, the occurrence information 5 and the related event information 6 are transmitted as the contents of a manual input to an incident report generation records part 9. At the same time, the routine is advanced from step 1702 to step 1703 so that the control is moved to an incident control part 1.

The processing of step 1703 will be described here using the flowchart of FIG. 19. In step 1801, a camera managed table 40, an electronic medical records client managed table 41 and an operation attribute table 42 are read. In step 1802, the event of one line is read from an operation history 13 shown in FIG. 2. In step 1803, it is compared with the contents of the occurrence information. One or a combination of two or more items compared may be used.

By way of example, whether an order ID and “OD0011” are in coincidence is checked. When they are not in coincidence, the routine is advanced to step 1808. When they are in coincidence, the routine is advanced to step 1804 and whether the related event output of the operation attribute table 42 corresponding to an operation name of the read event is set to Yes or No is checked. When it is set to No, the routine is advanced to step 1808. When it is set to Yes, the routine is advanced to step 1805 to transmit information on a predetermined item from the read event to an incident report generation records part 9.

In this example, event time, an operation name and an operation attribute of one line are transmitted to the incident report generation records part 9 and the routine is advanced to step 1806. In step 1806, when image extraction of the operation attribute table 42 corresponding to the operation name of the read event is set to No, the routine is advanced to step 1808. When it is set to Yes, in step 1807, an installation place is obtained from a client ID of the read event with reference to the electronic medical records client managed table 41. For example, a sickroom 1201 is obtained. Camera IDs are obtained from the obtained installation place with reference to the camera managed table 40.

For example, in this case, in the sickroom 1201, the camera IDs indicate 301 to 303. Extraction time before and after the event is obtained from the image extraction time of the operation attribute table 42 corresponding to the operation name of the event to transmit them to a monitoring image extraction part 36 together with the above camera IDs. In step 1808, whether reading of the line of the last of the operation history 13 is completed and the processing is ended is decided. When it is not ended, the above processing is repeated from step 1802. When the line of the last is an end, the processing of extracting a related event is ended and the routine is advanced to step 1704.

In step 1704, the control is moved to a monitoring image control part 32. In step 1704, combinations of the camera IDs and the image extraction time transmitted in step 1703 are sequentially transmitted corresponding to the monitoring image extraction part 36, and the monitoring image specified from a monitoring image database 33 is extracted to be transmitted to the incident report generation records part 9.

The control is moved to the incident control part 1. In step 1705, as the processing of the incident report generation records part 9, for the operation name in which both the related event output and the image extraction are set to Yes in the operation attribute table 42, the contents of an item of the event transmitted in step 1805 and the monitoring image transmitted in step 1704 are the contents of an auto input, whereby the contents of the auto input and the contents of the manual input inputted to the related event information 6 in step 1702 are compounded to generate and store an incident report. As the compounding method, for example, texts may be simply compounded in order of the contents of an auto input and the contents of a manual input. To clearly show the difference between the contents of an auto input and the contents of a manual input, the background color may be changed or a tag may be given.

The incident report recorded into an incident database 4 can be displayed in the incident input and output part 2 by the same method as the first embodiment. For example, patient. ID “P0001” is inputted to an incident report input/reference screen 18 to depress a call button 11 by the screen operation device such as a mouse, a desired incident report is referred by an incident report call part 10, and the result can be displayed on an incident report display screen 43 of FIG. 17.

For the related event information, the contents of an auto input of a doctor's related event 20, a pharmacist's related event 21 and a nurse's related event 22 and the contents of a manual input thereunder are displayed as in the first example of the first embodiment. The point different from the first example of the first embodiment is in that monitoring image selection 44 for selecting a monitoring image is displayed and there exists monitoring information 37 displaying a monitoring image.

In the monitoring image selection 44, monitoring images corresponding to the related events are lined from the upper side to the lower side. For example, when monitoring image c is selected by a screen operation device such as a mouse, moving images of 300 seconds before a doctor completes a prescription order and 30 seconds thereafter can be displayed in the monitoring information 37. An image of the camera and voice from a microphone incorporated into the camera may be compounded for storing in the monitoring image database and playing.

One of the cameras is installed so that the screen of an electronic medical records client operated by a doctor can be seen, thereby recording and playing the state of the operation by an image or voice. Why an event related to an incident has occurred may be exactly recorded. When there are a plurality of cameras corresponding to one related event and a plurality of extracted moving images, the monitoring image c may be selected by a mouse so as to play them in descending or ascending camera ID order in the monitoring image display 37. The displayed moving image may be played, stopped, fast forwarded and rewound.

According to the second embodiment, a related event related to an incident are extracted from an operation history stored into an electronic medical records database, time and the contents of an act in which an electronic medical record is operated and monitoring images at time therebefore and thereafter can be displayed on an incident report display screen. Simplified incident report input can be done while maintaining the exactness.

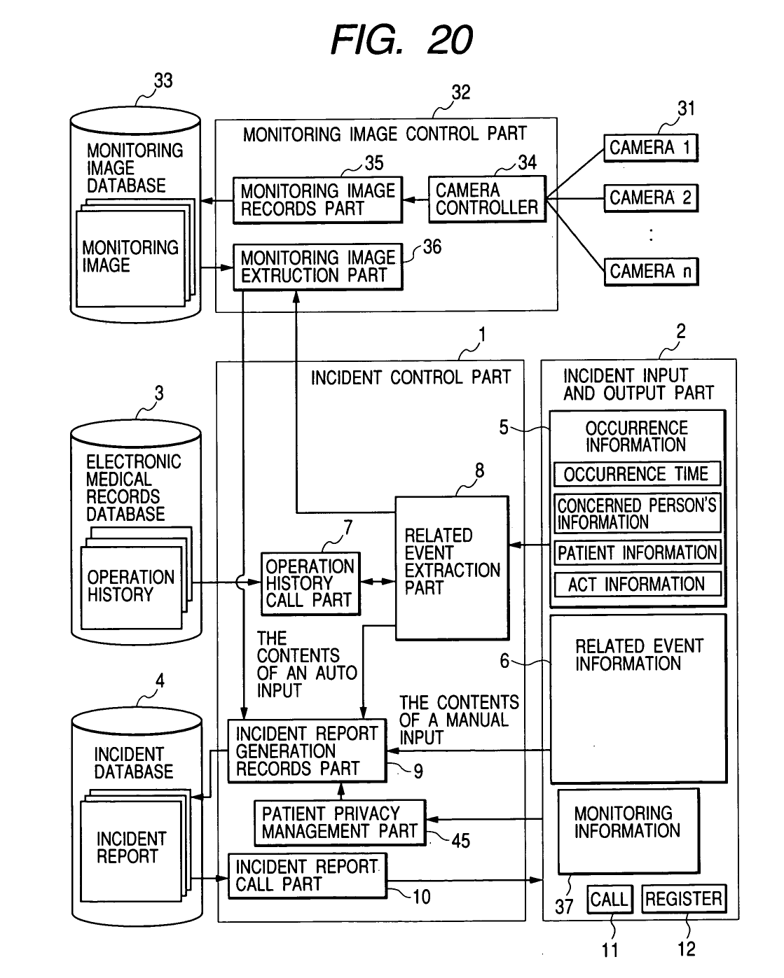

A third embodiment will be described using FIGS. 20 to 25. The third embodiment extends the second embodiment and can utilize a monitoring image related to the privacy of a patient such as a sickroom in an incident report with patient recognition.

FIG. 20 is a diagram showing the schematic configuration of a function block and a data flow of a hospital risk management support system capable of inputting a monitoring image to an incident report in consideration of the privacy of a patient according to the third embodiment. FIG. 20 is different from FIG. 12 in that a patient privacy management part 45 managing the privacy of a patient is added to an incident control part 1.

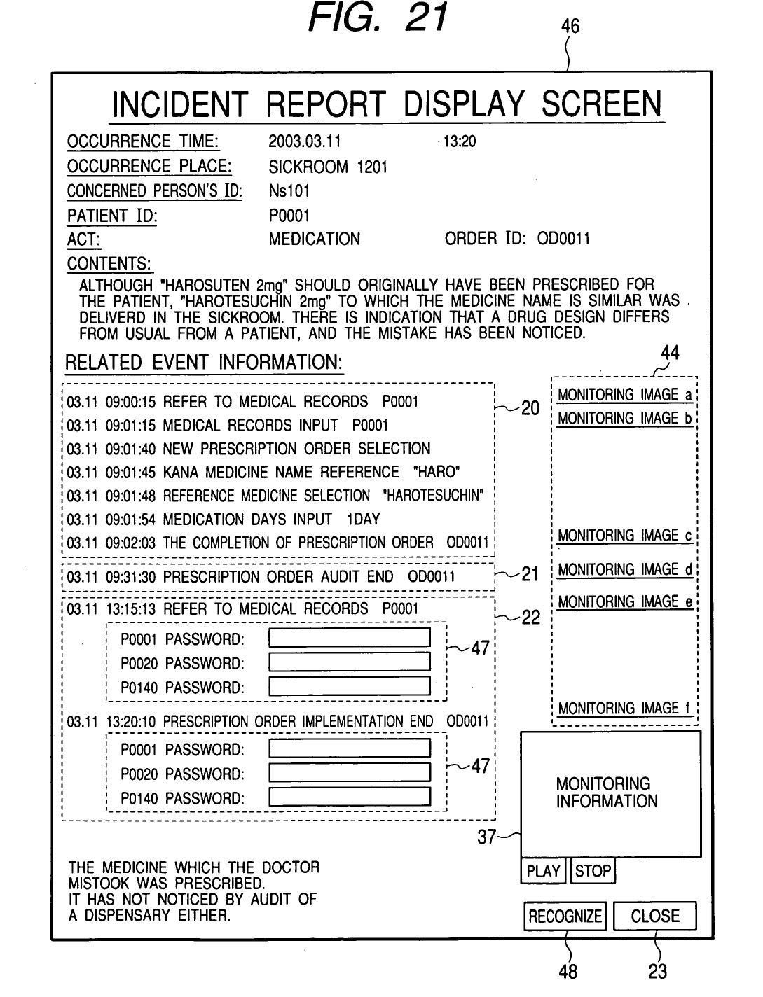

FIG. 21 is a diagram showing an example of an incident report display screen 46 capable of displaying a monitoring image in consideration of the privacy of a patient according to the third embodiment.

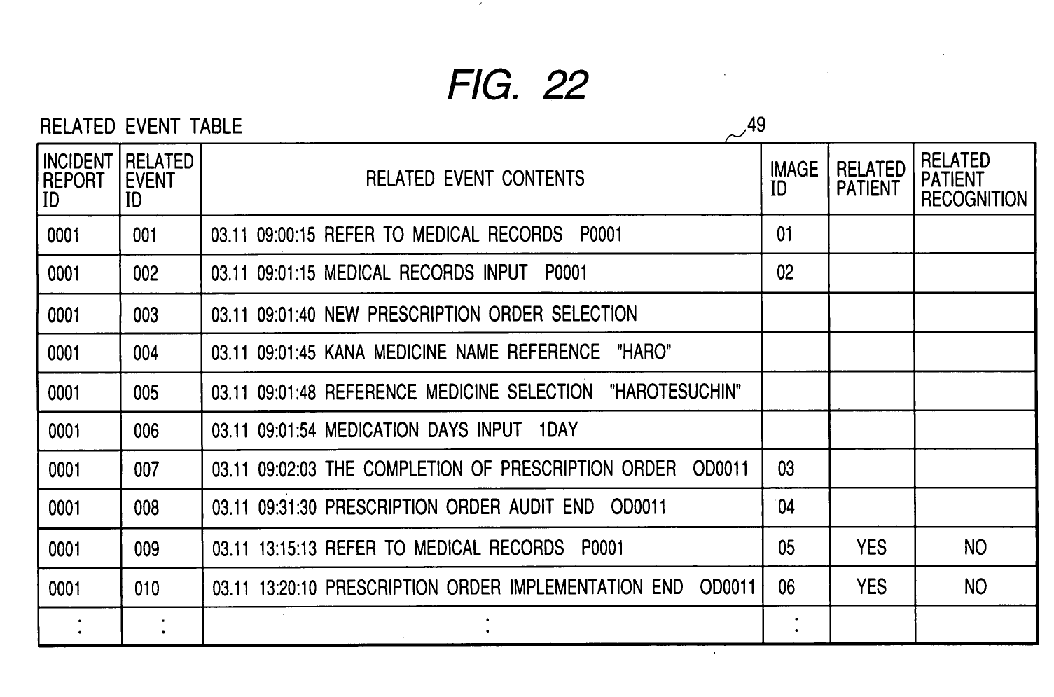

FIG. 22 is a diagram showing an example of a related event table (the essential part of the reference results) 49 managing related patient recognition for each related event according to the third embodiment. Other than the items of “related patient” and “related patient recognition”, it is the same as the case that the related event information created along the flowcharts of FIGS. 18 and 19, which are described in the second embodiment, is stored in a table form.

The related event table of FIG. 22 has lines each identified by an incident report ID and a related event ID locally given to each incident report. As the items, in addition to related event contents, there are an image ID corresponding to the related event, an item of “related patient” showing whether there is any related patient requiring the recognition of the image, and when the recognition is necessary, an item of “related patient recognition” holding whether all the related patients recognize the image.

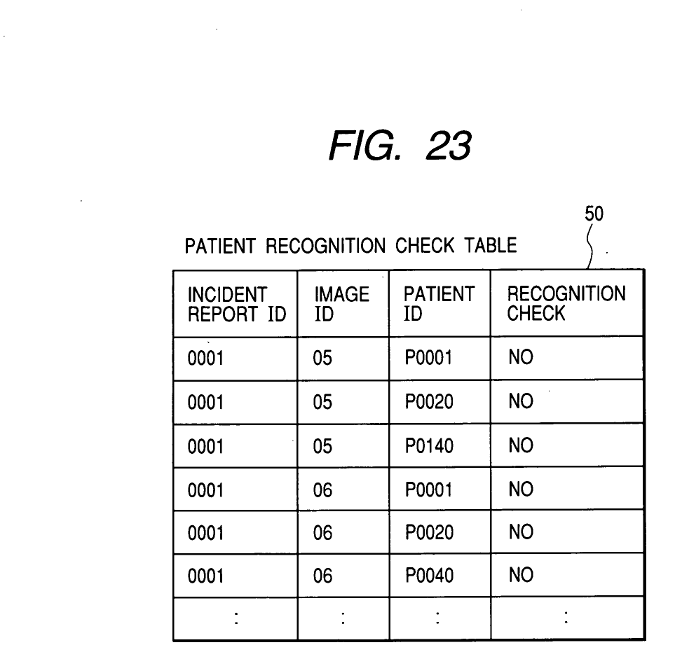

FIG. 23 is a diagram showing an example of a patient recognition check table 50 deciding “related patient recognition” of the related event table 49 of FIG. 22 and managing each patient recognition check.

The patient recognition check table 50 has lines each identified by an incident report ID, an image ID and a recognition patient ID, and an item of “recognition check” holding whether each patient recognizes an image requiring patient recognition in an incident report. Only when all the patients related to one image ID recognizes the image, the “related patient recognition” of the related event table 49 is set to “Yes”.

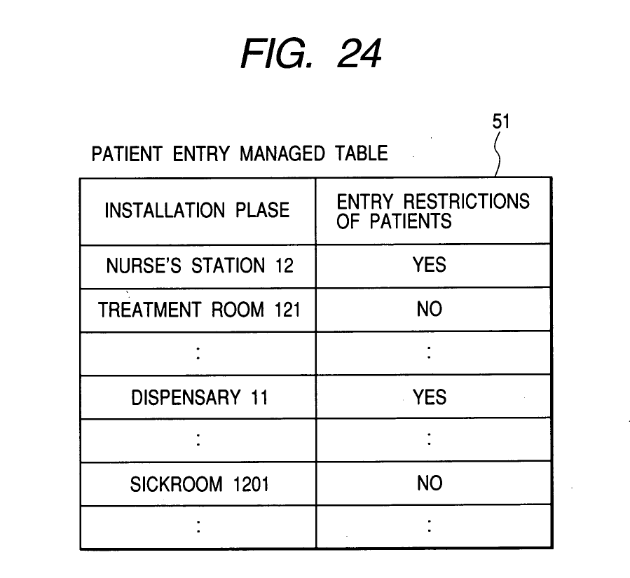

FIG. 24 is a diagram showing an example of a patient entry managed table 51 showing whether the installation places of electronic medical records clients and cameras restrict patient entry according to the third embodiment. For the item of the “related patient” of the related event table 49, with reference to the patient entry managed table 51 of FIG. 24, “No” may be decided for a place with entry restrictions of patients and “Yes” may be decided for a place without entry restrictions of patients.

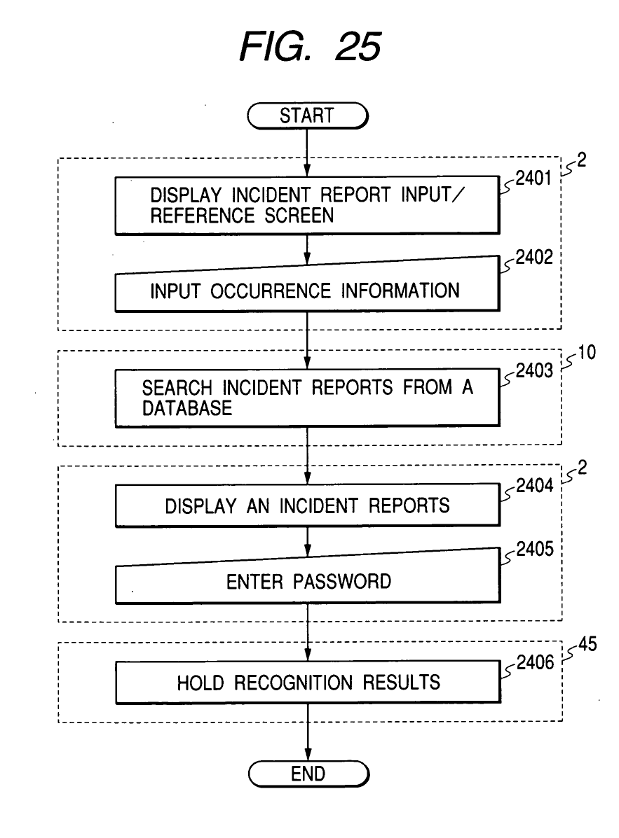

FIG. 25 is a flowchart showing a typical recognition operation of a hospital risk management support system capable of controlling the privacy of a patient to a monitoring image according to the third embodiment of the present invention.

Using FIGS. 20 to 23, the procedure of incident report patient recognition will be described below based on the flowchart of FIG. 25. The structure of a screen is almost the same as FIG. 17 of the second embodiment. FIG. 21 is an example of the incident report display screen 46. The different point is in that the patient recognition check 47 is displayed to obtain recognition for each patient.

In step 2401, an incident report input/reference screen 18 is displayed. In step 2402, occurrence information 5 is inputted to refer to an incident report. Here, order ID “OD0011” is inputted. A call button 11 is depressed for reference by an incident report call part 10 from an incident database 4 in step 2403.

In step 2404, the reference results are displayed on an incident report display screen 46. For the related event information, when there are the contents of a related event and an image based a related event table 49 as the essential part of the reference results, a character string capable of reference to the image, for example, “monitoring image a” is displayed. At this time, when “related patient” is set to “Yes” and “related patient recognition” is set to “No”, a patient recognition check table 50 is referred. When “recognition check” of a patient corresponding to an incident report ID and an image ID is set to “No”, a patient ID and a password input area are displayed for patient recognition check 47. The above processing is performed to all the related events. When the contents of a manual input of the occurrence information 5 and related event information 6 are displayed, the incident report display screen 46 is shown.

In the example shown in FIG. 21, there requires recognition of three patients “P0001”, “P0020”, and “P0140” in hospital in a sickroom 38 which may be photographed by cameras 31 in the implementation of a nurse, for each of the related event “13:15:13 Refer to medical records P0001” and “13:20:10 The completion of prescription order OD0011”.

As the recognition method, for example, in step 2405, a password which has been registered previously for each patient is inputted to depress a recognize button 48. In coincidence of the password, the item of “recognition check” of the corresponding patient of the patient recognition check table 50 is set to “Yes”. When recognition of all the patients related to the corresponding image ID is obtained, the item of “related patient recognition” of the related event table 49 is set to “Yes”. After receiving patient recognition, monitoring image e or monitoring image f is clicked to display the image in monitoring information 37. For the once recognized image, the edited related event table 49 may be stored to omit the recognition processing after the next reference.

According to the third embodiment, a related event related to an incident is extracted from an operation history stored in an electronic medical records database. Time and the contents of an act in which an electronic medical record is operated and monitoring images at time therebefore and thereafter are utilized with patient recognition. Simplified incident report creation can be done while respecting the privacy of a patient and maintaining the exactness.

As described above, according to the hospital risk management support system of the present invention, a related event related to an incident is extracted from an operation history stored in an electronic medical records database. Time and the contents of an act in which an electronic medical record is operated are utilized. Simplified incident report creation can be done while maintaining the exactness.

Other than time and the contents of an act in which an electronic medical record is operated, monitoring images of the states of electronic medical records operation and of the implementation of a nurse at time therebefore and thereafter are utilized. Simplified incident report creation can be done while maintaining the exactness.

In the case of a sickroom in which information on the privacy of a patient is included in a monitoring image, the monitoring image is utilized with patient recognition. Simplified incident report creation can be done while respecting the privacy of a patient and maintaining the exactness.

The present invention can provide a hospital risk management support system which can enhance the objectivity of an incident report and improve the input efficiency.

What is claimed is:

1. A hospital risk management support system comprising an incident input and output part inputting occurrence time, concerned person's information, patient information and act information related to an incident, and an incident control part controlling information on an incident, said incident control part having an operation history call part calling from an electronic medical records database an operation history which has recorded the history of operation of at least one electronic medical records client, a related event extraction part extracting from said operation history an event related to an incident having at least occurrence time and the contents of an act related operation based on all or part of said occurrence time, said concerned person's information, said patient information and said act information, which are inputted in said incident input and output part, and an incident report generation records part compounding the contents of an auto input having information on said chronological event extracted by said related event extraction part and the contents of a manual input in which information on said event is manually inputted in said incident input and output part so as to create an incident report.

2. A hospital risk management support system comprising (a) an incident input and output part inputting occurrence time, concerned person's information, patient information and act information related to an incident, (b) an incident control part controlling information on an incident, and (c) a monitoring image control part having a camera installed in the position in which a monitoring object can be observed, a camera controller controlling said camera, a monitoring image records part recording monitoring images photographed by at least one camera into a monitoring image database in succession, and a monitoring image extraction part extracting a monitoring image of desired extraction time and at least one camera, said incident control part having an operation history call part calling from an electronic medical records database an operation history which has recorded the history of operation of an electronic medical records client, a related event extraction part extracting from said operation history an event related to an incident having at least occurrence time and the contents of an act related operation based on all or part of said occurrence time, said concerned person's information, said patient information and said act information, which are inputted in said incident input and output part, said related event extraction part transmitting to said monitoring image extraction part the corresponding camera in the installation place of an electronic medical records client which has recorded said extracted event and predetermined extraction time which has predicted that said event is monitored in such a manner that said event is started from the occurrence time of said event to be ended, and an incident report generation records part inputting as the contents of an auto input a monitoring image related to said event extracted from said monitoring image extraction part and the contents of said event for compounding the contents of said event and the contents of a manual input manually inputted in said incident input and output part so as to create an incident report.

3. A hospital risk management support system comprising (a) an incident input and output part inputting occurrence time, concerned person's information, patient information and act information related to an incident, (b) an incident control part controlling information on an incident, and (c) a monitoring image control part having a camera installed in the position in which a monitoring object can be observed, a camera controller controlling said camera, a monitoring image records part recording monitoring images photographed by at least one camera into a monitoring image database in succession, and a monitoring image extraction part extracting a monitoring image of desired extraction time and at least one camera, said incident control part having an operation history call part calling from an electronic medical records database an operation history which has recorded the history of operation of an electronic medical records client, a related event extraction part extracting from said operation history an event related to an incident having at least occurrence time and the contents of an act related operation based on all or part of said occurrence time, said concerned person's information, said patient information and said act information, which are inputted in said incident input and output part, said related event extraction part transmitting to said monitoring image extraction part the corresponding camera in the installation place of an electronic medical records client which has recorded said extracted event and predetermined extraction time which has predicted that said event is monitored in such a manner that said event is started from the occurrence time of said event to be ended, an incident report generation records part inputting as the contents of an auto input a monitoring image related to said event extracted from said monitoring image extraction part and the contents of said event for compounding the contents of said event and the contents of a manual input manually inputted in said incident input and output part so as to create an incident report, and a patient privacy management part which can display a monitoring image only when the monitoring image related to the privacy of a patient of said incident report is recognized by the input of information specifying an individual set by the patient.
